(19) United States
(12) Patent Application Publication
(10) Pub. No.: US 2006/0031517 A1
(43) Pub. Date: Feb. 9, 2006

(54) Information transfer system and method

(76) Inventors: Richard Carl Gossweiler III, Santa Clara, CA (US); Himanshu Raj, Atlanta, GA (US); Dejan Milojicic, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,062

(22) Filed: Jan. 30, 2004

(51) Int. Cl. G06F 15/16

(52) U.S. Cl. 709/227

(57) ABSTRACT

An information transfer system includes a content exchange appliance and an information communication device. The content exchange appliance includes a transmitter that transmits information to be stored. The information communication device is configured to communicate with the content exchange appliance and the content exchange appliance transmits the information for storage when the communication between the content exchange appliance and the information communication device indicates that the information communication device has been hovering within a given proximity to the content exchange appliance for at least a hovering time.

### BACKGROUND OF THE INVENTION

The present invention is generally directed to an information transfer system and method. The present invention is more particularly directed to a system and method for combining natural human movement patterns with presence sensing technology to implicitly filter and segment automatically downloaded streams of data.

As the cost for large screen displays continues to decrease, an increasing number of digital content display devices are seen in public spaces. Content exchange appliances (CEA's) enhance the otherwise display-only experience by allowing people to observe something interesting and take that information in various formats. It has been hypothesized that the public will be willing to accept such downloads if the downloading task does not distract them from their initial goal of experiencing the information on the display screen. Unfortunately, even with familiar personal devices such as personal digital assistance (PDA) devices or cell phones to receive the information, users must explicitly take out the device, activate it, and interpolate through a physically disconnected interface with the public display.

Systems requiring no interaction between the public and the content exchange devices to achieve information download has the upside that the user is completely unencumbered with their primary task of watching the display. However, interaction at the point of gathering information may merely be postponed until a later time wherein harvesting the desired information is required. Also, automatic information gathering may unduly burden bandwidth and memory capacity for storing the information.

As can be seen from the foregoing, there is a need in the art for a new and improved system and method which provides a filter on when information is downloaded while requiring no explicit interaction on the part of the user and allows the user to capture a segment of information over a defined time period. As a result, information downloading would be made more efficient while not imposing a distraction to the primary task of watching the display.

### SUMMARY OF THE INVENTION

The invention provides a content exchange appliance comprising a transmitter that transmits information for storage and that communicates with an information communication device. The content exchange appliance transmits the information for storage when the communication between the content exchange appliance and information communication device indicates that the information communication device has been hovering within a given proximity to the content exchange appliance for at least a hovering time.

The invention further provides an information communication device comprising a transmitter that transmits signals to a content exchange appliance and a receiver that receives signals from the content exchange appliance. The transmitter and receiver provide communication with the content exchange appliance. The communication with the content exchange appliance enables a time of hovering within a given proximity to the content exchange appliance to be determined to cause the content exchange appliance to transmit information for storage.

The invention still further provides a method comprising detecting when a first and second device are within a given proximity to each other, timing the hovering time that the first and second devices are within the given proximity to each other, and transmitting information from one of the first and second devices for storage when the hovering time exceeds a predetermined duration.

These and various other features as well as advantages of the present invention will be apparent from a reading of the following detailed description and a review of the associated drawings.

### BRIEF DESCRIPTION OF THE DRAWINGS

FIG. 1 is a schematic block diagram of an information transfer system according to an embodiment of the present invention illustrating two configurations for transmitting information from a content exchange appliance for storage in an information storage device;

FIG. 2 is a flow chart describing a first embodiment according to the present invention for transferring information from a content exchange appliance in response to sufficient hovering between the content exchange appliance and an information communication device;

FIG. 3 is a flow chart according to another embodiment of the present invention in which communication between the content exchange appliance and the information communication device may be initiated;

FIG. 4 is a flow chart according to a further embodiment of the present invention for initiating communication between the content exchange appliance and the information communication device;

FIG. 5 is a flow chart according to a further embodiment of the present invention wherein hovering time is determined within the information communication device; and

FIG. 6 is a flow chart according to a still further embodiment of the invention for transmitting the data after the hovering time has been determined by the information communication device as illustrated in FIG. 5.

### DESCRIPTION OF THE INVENTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

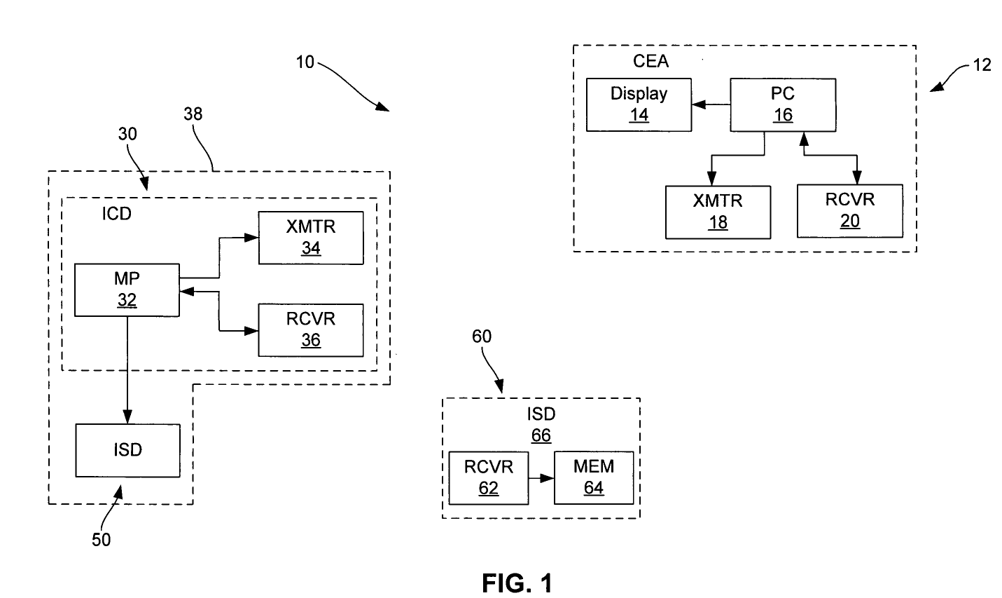

Referring now to FIG. 1, it illustrates an information transfer system 10 embodying the present invention. The system 10 generally includes a content exchange appliance 12, an information communication device 30, and first and second information storage devices 50 and 60, respectively.

The content exchange appliance (CEA) includes a display 14, a computer 16 such as a personal computer, a transmitter 18, and a receiver 20. The display 14 may take the form of a plasma display, a cathode ray tube, or a liquid crystal display, for example. It receives information from the computer 16 and displays the same for public viewing. The computer 16 maintains the displayed information or information related thereto in storage for potential transmission to an information storage device (ISD) and also for establishing communication with an information communication device (ICD). The receiver 20 is also coupled to the computer 16 for use in establishing communication between the CEA and an ICD.

The ICD 30 generally includes a microprocessor 32, a transmitter 34, and a receiver 36. The first ISD 50, as illustrated, is directly coupled to the microprocessor 32 of the ICD 30 and is contained within a common enclosure 38 with the ICD 30.

The second ISD 60 includes a receiver 62 and a memory 64. The receiver 62 and memory 64 are housed within an enclosure 66 which is separate and apart from the enclosure 38 of the ICD 30. The receiver 62 is configured to receive the information transmitted from the CEA 12 and stores the information within the memory 64. Hence, when ISD 60 is utilized, the information is transmitted directly from the CEA 12 to the ISD 60 for storage.

In contrast, when the first ISD 50 is utilized, the information is first transmitted to the ICD 30. The information is then transferred from the ICD 30 to the ISD 50 for storage therein.

In accordance with the broader aspects of the present invention, when a user carrying the ICD 30 with either the built in ISD 50 or the separate ISD 60, approaches the CEA 12, for example to watch some interesting content displayed on the display 14 and is within a given proximity of the CEA 12, “hovering” begins. When the person has stood within the given proximity of the CEA 12 and has hovered for a configurable or predefined amount of time, the user is deemed “interested” in receiving the displayed information or information related thereto, and automatic transmission of the information begins between the CEA 12 and the ICD 30 for storage in the ISD 50 or directly to the ISD 60 for storage. This downloading continues until the user is deemed “uninterested” by walking away and out of the given proximity to the CEA 12. Hence, discrete units of information as well as a segment of streaming information may be gathered based on natural human movement patterns and presence sensing to achieve information transfer without distracting from the original intent of the user to watch the display 14. The flow diagrams which follow hereinafter more particularly describe methods by which the foregoing may be achieved in accordance with various embodiments of the present invention.

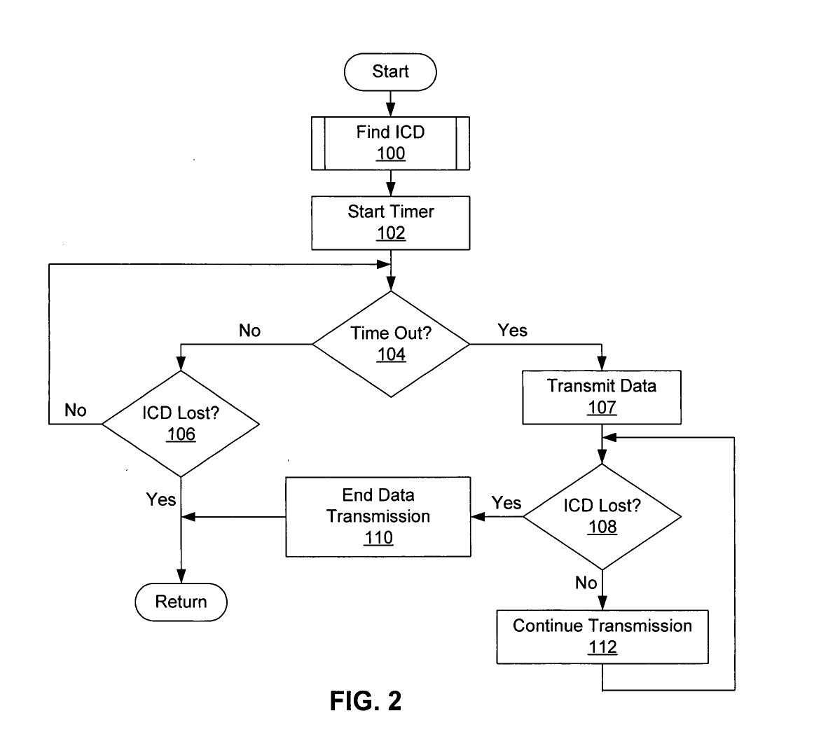

Referring now to FIG. 2, it illustrates a flow chart describing the overall operation of the system 10 in accordance with a first embodiment of the present invention. The process begins with activity block subroutine 100 wherein the information communication device is found. More particularly, in subroutine 100, an ICD is determined to be within a given proximity of the CEA. Following activity block 100, the process advances to activity block 102 wherein a timer is started. The timer used herein may be employed within the ICD 30 or the CEA 12. The timer times the time in which the ICD is within the given proximity of the CEA.

Once the timer is started in accordance with activity block 102, the process advances to decision block 104 where it is determined if there has been a time out of the hovering timer started in activity block 102. If there has not been a time out, the process advances to decision block 106 to determine if the ICD has exited the given proximity to the CEA. If the ICD remains within the given proximity to the CEA, the process returns to decision block 104. If there is a time out of the hovering timer as determined in decision block 104 and if the ICD has exited the given proximity to the CEA, the process returns. However, if there is a time out of the hovering timer, indicating that the ICD (and thus the user carrying the ICD) has remained within the given proximity to the CEA for a sufficient period of time to demonstrate interest, the process advances to activity block 107 wherein the displayed information or information related to the information displayed on the display 14 is transmitted. The transmitted information will be received by either the ICD for storage in the ISD 50, or by the ISD 60 directly for storage in memory 64. Once transmission of the information has begun in accordance with activity block 107, it is determined if the ICD 30 has exited the given proximity to the CEA 12. If it has, the ICD will be considered to have been lost and the process immediately advances to activity block 110 wherein the transmission of the information is terminated. After such termination of the transmission, the process returns.

If however in implementing decision block 108, it is determined that the ICD 30 has not left the given proximity to the CEA, the process advances to activity block 112 for continuing the transmission of the information. As will be noted, the transmission of the information continues as long as the ICD 30 remains within the given proximity to the CEA. Once the ICD leaves the given proximity to the CEA, the transmission terminates.

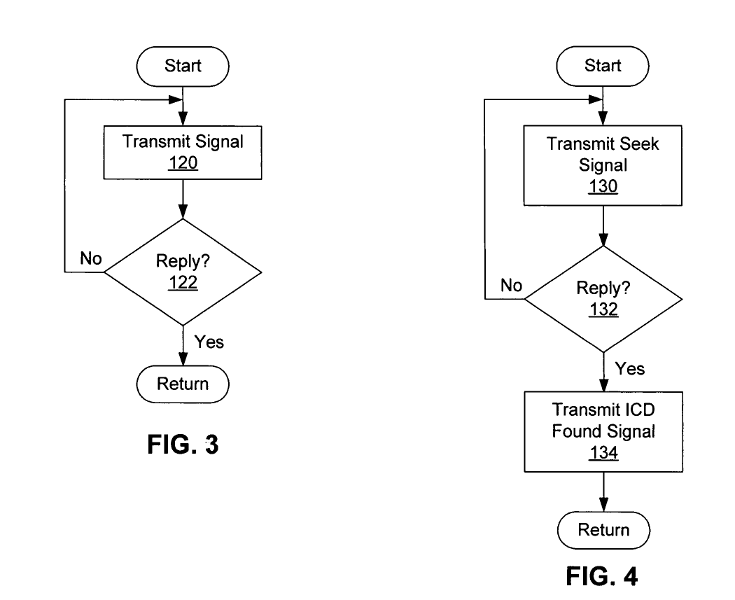

FIG. 3 illustrates a flow chart of one embodiment of the invention for implementing activity block 100 of FIG. 2. Here, the CEA 12 implements activity block 120 by transmitting a seek signal. After transmission of the seek signal begins, the CEA 12 implements decision block 122 to determine if it has received a reply to the seek signal. If it has not received a reply, the CEA 12 continues transmitting the seek signal. If it is determined in decision block 122 that the CEA 12 has indeed received a reply to the seek signal, the CEA will then be notified that an ICD, such as ICD 30, is within the given proximity to the CEA 12, and that the process should advance to activity block 102 of FIG. 2 for starting the hovering timer.

FIG. 4 shows another embodiment of the present invention for implementing activity block 100 of FIG. 2. The subroutine of FIG. 4 initiates with activity block 130 wherein the ICD 30 transmits the seek signal. Once the seek signal transmission has begun, the ICD 30 through its receiver 36 determines in decision block 132 if it has received a reply to its seek signal. If it hasn't, the ICD continues to transmit the seek signal. However, if the ICD 30 has received a reply, the ICD then advances to activity block 134 where it transmits an ICD found signal. The ICD found signal, when received by the CEA 12, will notify the CEA 12 that the ICD is within the given proximity to the CEA 12, and that the CEA 12 is to implement activity block 102 of FIG. 2.

The ICD 30 may transmit the seek signal intermittently. This may be done to extend battery lifetime of the ICD 30.

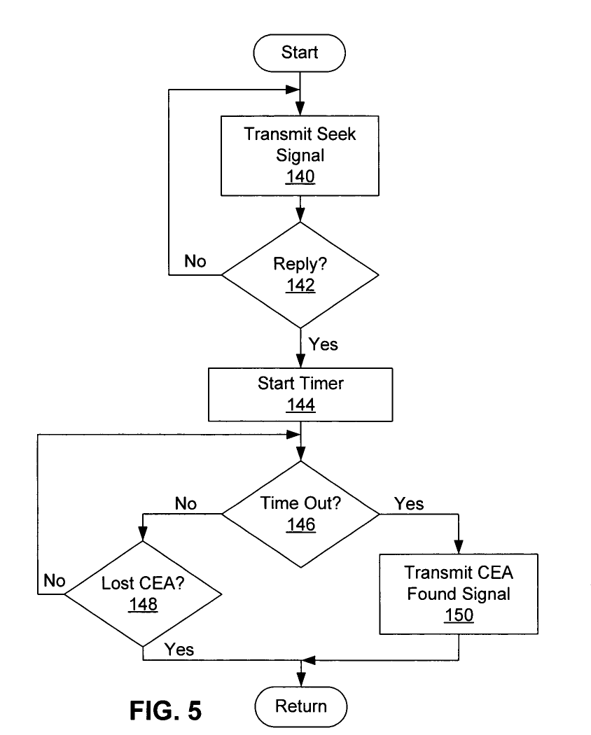

Referring now to FIG. 5, it illustrates a further embodiment of the present invention wherein the hovering time is timed within the ICD. The process of FIG. 5 initiates with activity block 140 wherein the ICD 30 transmits a seek signal. Once transmission of the seek signal begins, the ICD 30 determines if it has received a reply to its seek signal in decision block 142. If it has not received a reply, the ICD continues to transmit the seek signal. However, if the ICD 30 has received the reply, notifying the ICD 30 that it is within the given proximity of the CEA 12, the process advances to activity block 44 wherein the ICD starts the hovering timer. Once the hovering timer is started, the process advances to activity block 146 wherein the ICD determines if there has been a time out of the hovering time. If there has not been a time out, the process advances to decision block 148 wherein it is determined by the ICD if the ICD has been moved outside of a given proximity to the CEA and hence if the CEA has been lost. If the ICD has not been so moved, the process returns to decision block 146. However, if the ICD 30 has been moved out of the given proximity to the CEA 12 before a time out of the hovering timer, the process returns.

If there is a time out of the hovering timer as determined in decision block 146, the process then advances to activity block 150 wherein the ICD transmits a CEA found signal. The CEA found signal, when received by the CEA, notifies the CEA that an ICD is within its given proximity and has been so for a sufficient period of time to designate that the user of the ICD has interest in the information being displayed on its display 14.

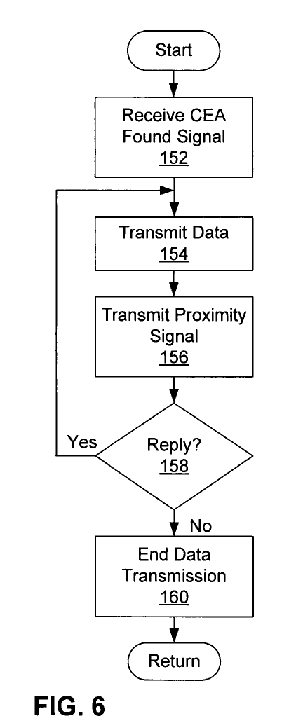

The process of FIG. 5 continues with the process of FIG. 6. It initiates at activity block 152 wherein the CEA found signal is received by the CEA 12. In response to receiving the CEA found signal, the process advances to activity block 154 wherein the CEA 12 initiates transmission of the information associated with the information displayed on the display 14. During the transmission of the information, the CEA 12 implements activity block 156 for transmitting a proximity signal. The proximity signal is transmitted for receipt by the ICD 30 to determine that the ICD 30 has remained within the given proximity to the CEA. To that end, during transmission of the proximity signal, the process advances to 158 where the CEA 12 determines if it has received a reply to its proximity signal. If it has received a reply, then the process returns to activity block 154 for continued transmission of the data and the proximity signal. However, if the CEA 12 receives a reply to its proximity signal, the process advances to activity block 160 wherein the CEA terminates transmission of the information. The process then returns.

As may be seen from the foregoing, the present invention provides a system and method which allows a user to approach a content exchange appliance with an information communication device, hover by standing near the communication exchange appliance for a configurable time period to indicate interest, and automatically receive downloaded information from the content exchange appliance until the user walks away and out of the given proximity to the content exchange appliance. This system and method provides a mechanism which reduces the amount of work and disruption that the user must endure to obtain interesting information. It creates a strong filter on when to download information and allows the user to capture the information of interest over a time period determined by the interest of the user.

In practicing the present invention, the ICD 30 may be a Bluetooth® enabled cell phone, as for example a Nokia® 3650 cell phone. The display of the CEA may be a plasma display and the computer 16 may be a consumer-level PC computer. The cell phone may then serve as both the ICD and the ISD as it has internal storage. The plasma display and the personal computer may then serve as the CEA. As an alternative of the Bluetooth® protocol, an 80211 wireless protocol, may be employed.

Although the present invention has been described in considerable detail with reference to certain preferred embodiments, other embodiments are possible. Therefore, the spirit or scope of the appended claims should not be limited to the description of the embodiments contained herein. It is intended that the invention resides in the claims.

We claim:

1. A content exchange appliance comprising:
a transmitter that transmits information for storage and that communicates with an information communication device, the content exchange appliance transmitting the information for storage when the communication between the content exchange appliance and information communication device indicates that the information communication device has been hovering within a given proximity to the content exchange appliance for at least a hovering time.

2. The content exchange appliance of claim 1 further comprising a timer that times the hovering time.

3. The content exchange appliance of claim 2 wherein the transmitter transmits a seek signal and begins timing the hovering time in response to receipt of a reply to the seek signal from the information communication device.

4. The content exchange appliance of claim 3 wherein the timer begins timing the hovering time in response to receipt of the seek signal from the information communication device.

5. The content exchange appliance of claim 2 wherein the transmitter transmits a reply signal upon receipt of a seek signal from the content exchange appliance and wherein the timer begins timing the hovering time in response to receipt of a device found signal from the information communication device.

6. The content exchange appliance of claim 1 wherein the transmitter terminates transmission of the information when the information communication device is outside of the given proximity to the content exchange appliance.

7. The content exchange appliance of claim 1 wherein the transmitter transmits the information for storage directly to a storage device.

8. The content exchange appliance of claim 1 further comprising a display that displays information related to the information for storage.

9. An information communication device comprising:
a transmitter that transmits signals to a content exchange appliance; and
a receiver that receives signals from the content exchange appliance, the transmitter and receiver providing communication with the content exchange appliance,
wherein the communication with the content exchange appliance enables a time of hovering within a given proximity to the content exchange appliance to be determined to cause the content exchange appliance to transmit information for storage.

10. The information communication device of claim 9 wherein the transmitter transmits a reply signal in response to a seek signal received from the content exchange appliance.

11. The information communication device system of claim 9 wherein the transmitter transmits a seek signal to the content exchange appliance.

12. The information communication device system of claim 9 wherein the transmitter transmits a content exchange appliance seek signal; and wherein the transmitter transmits a found signal in response to a reply signal received from the content exchange appliance.

13. The information communication device of claim 9 further comprising a timer that times the hovering time.

14. The information communication device of claim 13 wherein the transmitter transmits a seek signal and the timer begins timing the hovering time in response to receipt of a reply from the content exchange appliance to the seek signal.

15. The information communication device of claim 9 wherein the receiver receives the information for storage from the content exchange appliance and the transmitter transmits the information for storage to a storage device.

16. A method comprising:
detecting when a first and second device are within a given proximity to each other;
timing the hovering time that the first and second devices are within the given proximity to each other; and
transmitting information from one of the first and second devices for storage when the hovering time exceeds a predetermined duration.

17. The method of claim 16 comprising the further step of terminating transmission of the information when the first and second devices transition from within the given proximity to each other to outside of the given proximity.

18. The method of claim 16 wherein the timing step is performed by one of the first and second devices.

19. The method of claim 16 wherein the detecting step includes transmitting a seek signal from one of the first and second devices and receiving the seek signal by the other one of the first and second devices.

20. The method of claim 19 wherein the detecting step further includes transmitting a reply signal from the other one of the first and second devices to the one of the first and second devices in response to receipt of the seek signal.

21. The method of claim 16 comprising the further step of displaying information related to the transmitted information.
